(19) United States
(12) Patent Application Publication
(10) Pub. No.: US 2022/0250963 A1
(43) Pub. Date: Aug. 11, 2022

(54) GLASS ETCHING AND BREAKING APPARATUS AND METHODS OF USING THE SAME

(71) Applicant: Creator's Stained Glass, Inc., Spring Grove, IL (US)

(72) Inventors: Ray Nicholas, Ingleside, IL (US); Jordan Anderson, Gurnee, IL (US); Ryan Nicholas, Ingleside, IL (US)

(21) Appl. No.: 17/172,550

(22) Filed: Feb. 10, 2021

(51) Int. Cl. C03B 33/10; C03B 33/12

(52) U.S. Cl. CPC C03B 33/105; C03B 33/12

(57) ABSTRACT

A glass etching and breaking apparatus comprises a glass cutting tool and a flexible bridging element for inducing a score line into a pane of glass and aiding in breaking the pane of glass along the score line. The cutting tool is removable and storable within the body of the glass cutting apparatus. A magnet is provided for holding the cutting tool in place and for holding metal or magnetic objects. Methods of using the same are further provided.

### TECHNICAL FIELD

The present invention relates to a glass etching and breaking apparatus. Specifically, the glass etching and breaking apparatus of the present invention comprises a glass cutting tool and a flexible bridging element for inducing a score line into a pane of glass and aiding in breaking the pane of glass along the score line. The cutting tool is removable and storable within the body of the glass cutting apparatus. A magnet is provided for holding the cutting tool in place and for holding metal or magnetic objects. Methods of using the same are further provided.

### BACKGROUND

Glass cutting has been around for centuries, if not millennia. Tools have been developed to aid in allowing users to provide specific and desired score lines in panes of glass, and to break the panes of glass precisely along the score line. For example, to place a score line into a pane of annealed glass, a cutting tool is typically used. The cutting tool generally comprises a small cutting wheel made of hardened steel or tungsten carbide that is generally about 4 to about 6 mm in diameter with a V-shaped profile called a “hone angle.” The cutter is then rolled firmly over the glass, producing a “score line” or “fissure,” weakening the glass along this line. Tools, of course, have been developed to aid users in providing score lines in panes of annealed glass.

For example, a glass cutting apparatus called “Studio Pro™” by Diamond Tech and similar apparatuses comprise a hollow base with a grip on one side that is Tillable with oil (to aid as a lubricant in the cutting process), and a cutting tool extending form a corner thereof. The cutting tool may be used to etch a score line into a pane of glass, and the oil may drip from the base to lubricate the glass during the score line etching process. However, this apparatus tends to leak oil, is difficult to manage, and is unwieldy and difficult to hold and store due to the cutting tool that extends from the body at an oblique angle.

A need, therefore, exists for an improved glass etching and breaking apparatus. Specifically, a need exists for a glass etching and breaking apparatus having an extendible glass cutting tool that can be removed and changed. More specifically, a need exists for a glass etching and breaking apparatus having a storage slot or chamber within the body of the glass cutting apparatus for holding and storing the glass cutting tool so the same is not lost.

Breaking the glass along the score line is often the most difficult part of the process, in that if incorrectly done, or if the score line is not sufficient, the glass can break in locations that are unintended, leading to waste of the glass, and in more serious circumstances, injury to the user. Tools have been developed to aid in breaking glass along score lines as intended by users.

For example, a tool called the “Safety Break” from Morton Glass Works comprises a pair of parallel flexible bridging members attached together on each end. The bridging members can flex toward each other when depressed on one or the other side thereof. Thus, a pane of glass having a score line etched therein that is placed adjacent one of the flexible bridging members and pressed toward the bridging member causes the pane of glass and the bridging member to flex, breaking the pane of glass along the score line. A user can press upon the glass using his or her fingers, or may use another tool, such as a round button or the like. This tool can be effective at breaking a score line etched in a pane of glass where desired, but it is limited because it does not include a cutting tool as part of the apparatus, requiring a separate cutting tool to etch the score line.

A need, therefore, exists for an improved glass etching and breaking apparatus that provides both etching and aids in breaking a pane of glass. Specifically, a need exists for an improved glass etching and breaking apparatus comprising flexible members that can be used to break etched glass along a score line, while also including a cutting tool extending therefrom. More specifically, a need exists for an improved glass etching and breaking apparatus comprising a cutting tool that is removable and storable within the body of the flexible members, thereby holding and storing the cutting tool so the same is not lost.

### SUMMARY OF THE INVENTION

The present invention relates to a glass etching and breaking apparatus. Specifically, the glass etching and breaking apparatus of the present invention comprises a glass cutting tool and a flexible bridging element for inducing a score line into a pane of glass and aiding in breaking the pane of glass along the score line. The cutting tool is removable and storable within the body of the glass cutting apparatus. A magnet is provided for holding the cutting tool in place and for holding metal or magnetic objects. Methods of using the same are further provided.

To this end, in an embodiment of the present invention, a glass etching and breaking apparatus is provided. The glass etching and breaking apparatus comprises: a body comprising a first bridging leg and a second bridging leg in parallel relationship and a space therebetween, the first bridging leg configured to flex when pressure is applied thereto and to return to its original position when the pressure is removed, the first bridging leg connected to the second bridging leg at a first end of the body and the first bridging leg connected to the second bridging leg at the second end of the body; and a glass cutting tool extending from one of the first and second ends of the body, the glass cutting tool comprising a glass cutting element on an end thereof, the glass cutting tool extending from a cavity within the body.

In an embodiment, the cutting tool is removable from the cavity.

In an embodiment, the cavity comprises a tab, wherein the tab holds the glass etching and breaking apparatus in a first position, wherein when in the first position, a portion of the cutting tool extends from the body.

In an embodiment, when the cutting tool is turned around such that the cutting element is inserted first into the cavity, the cavity is configured to hold the cutting tool without any portion of the cutting tool extending from the body.

In an embodiment, the cutting tool comprises a reduced portion, such that when the cutting tool is turned around and when the cutting element is inserted first into the cavity, the reduced portion of the cutting tool clears the tab within the cavity.

In an embodiment, the first bridging leg has a first ridge on an inside surface thereof, wherein the first ridge guides the cutting tool when inserted into the cavity with the cutting element inserted first.

In an embodiment, the second bridging leg has a second ridge on an inside surface thereof, wherein the second ridge guides the cutting tool when inserted into the cavity with the cutting element inserted first.

In an embodiment, the glass etching and breaking apparatus further comprises a magnet disposed in the body proximate the cavity.

In an embodiment, the second bridging leg is configured to flex when pressure is applied thereto and to return to its original position when the pressure is removed.

In an embodiment, the cutting tool extends from the body at an oblique angle to the sides of the body.

In an alternate embodiment of the present invention, a method of using a glass etching and breaking apparatus is provided. The method comprises the steps of: providing a glass etching and breaking apparatus comprising: a body comprising a first bridging leg and a second bridging leg in parallel relationship and a space therebetween, the first bridging leg configured to flex when pressure is applied thereto and to return to its original position when the pressure is removed, the first bridging leg connected to the second bridging leg at a first end of the body and the first bridging leg connected to the second bridging leg at the second end of the body; and a glass cutting tool extending from one of the first and second ends of the body, the glass cutting tool comprising a glass cutting element on an end thereof, the glass cutting tool extending from a cavity within the body; etching a score line into pane of glass with the cutting tool; placing the pane of glass against a side of the body of the glass etching and breaking apparatus; pressing the score line of the pane of glass against the side of the body of the glass etching and breaking apparatus, thereby flexing the first leg thereof; and breaking the glass at the score line.

In an embodiment, the method further comprises the step of: removing the cutting tool from the cavity.

In an embodiment, the cavity comprises a tab, wherein the tab holds the glass etching and breaking apparatus in a first position, wherein when in the first position, a portion of the cutting tool extends from the body.

In an embodiment, the method further comprises the step of: inserting the cutting tool into the cavity with the cutting element inserted first into the cavity, wherein the cavity is configured to hold the cutting tool without any portion of the cutting tool extending from the body.

In an embodiment, the cutting tool comprises a reduced portion, and further comprises the step of: clearing the tab within the cavity with the reduced portion of the cutting tool when the cutting tool is inserted into the cavity with the cutting element inserted first.

In an embodiment, the first bridging leg has a first ridge on an inside surface thereof, and further comprises the step of: guiding the cutting tool with the first ridge when the cutting tool is inserted into the cavity with the cutting element inserted first.

In an embodiment, the second bridging leg has a second ridge on an inside surface thereof, and further comprises the step of: guiding the cutting tool with the second ridge when the cutting tool is inserted into the cavity with the cutting element inserted first.

In an embodiment, the method further comprises the steps of: providing a magnet disposed in the body proximate the cavity; and holding the cutting tool within the cavity with the magnet.

In an embodiment, the method further comprises the step of: holding a magnetic or metal item with the magnet.

In an embodiment, the second bridging leg is configured to flex when pressure is applied thereto and to return to its original position when the pressure is removed.

It is, therefore, an advantage and objective of the present invention to provide an improved glass etching and breaking apparatus.

Specifically, it is an advantage and objective of the present invention to provide a glass etching and breaking apparatus having an extendible glass cutting tool that can be removed and changed.

More specifically, it is an advantage and objective of the present invention to provide a glass etching and breaking apparatus having a storage slot or chamber within the body of the glass cutting apparatus for holding and storing the glass cutting tool so the same is not lost.

Moreover, a need exists for an improved glass etching and breaking apparatus that provides both etching and aids in breaking a pane of glass.

Specifically, it is an advantage and objective of the present invention to provide an improved glass etching and breaking apparatus comprising flexible members that can be used to break etched glass along a score line, while also including a cutting tool extending therefrom.

More specifically, it is an advantage and objective of the present invention to provide an improved glass etching and breaking apparatus comprising a cutting tool that is removable and storable within the body of the flexible members, thereby holding and storing the cutting tool so the same is not lost.

Additional features and advantages of the present invention are described in, and will be apparent from, the detailed description of the presently preferred embodiments and from the drawings.

### BRIEF DESCRIPTION OF THE DRAWINGS

The drawing figures depict one or more implementations in accord with the present concepts, by way of example only, not by way of limitations. In the figures, like reference numerals refer to the same or similar elements.

FIGS. 1A-1C illustrate various views of a glass etching and breaking apparatus in an embodiment of the present invention.

FIG. 2 illustrates a perspective view of a glass etching and breaking apparatus etching a score line into a pane of glass in an embodiment of the present invention.

FIG. 3 illustrates a side view of a glass etching and breaking apparatus with an etched pane of glass in an embodiment of the present invention.

FIG. 4 illustrates a top view of a glass etching and breaking apparatus having the cutting tool removed therefrom in an embodiment of the present invention.

FIG. 5 illustrates a top view of a glass etching and breaking apparatus in an upright configuration having the cutting tool removed therefrom.

FIG. 6 illustrates a top view of a glass etching and breaking apparatus having the cutting tool turned around and disposed within a storage cavity within the same in an embodiment of the present invention.

FIG. 7 illustrates a perspective view of a glass etching and breaking apparatus having the cutting tool inserted completely therein in an embodiment of the present invention.

FIG. 8 illustrates a perspective view of a glass etching and breaking apparatus having the cutting tool stowed therein and having a metal or magnetic item magnetically connected thereto in an embodiment of the present invention.

### DETAILED DESCRIPTION OF THE PRESENTLY PREFERRED EMBODIMENTS

The present invention relates to a glass etching and breaking apparatus. Specifically, the glass etching and breaking apparatus of the present invention comprises a glass cutting tool and a flexible bridging element for inducing a score line into a pane of glass and aiding in breaking the pane of glass along the score line. The cutting tool is removable and storable within the body of the glass cutting apparatus. A magnet is provided for holding the cutting tool in place and for holding metal or magnetic objects. Methods of using the same are further provided.

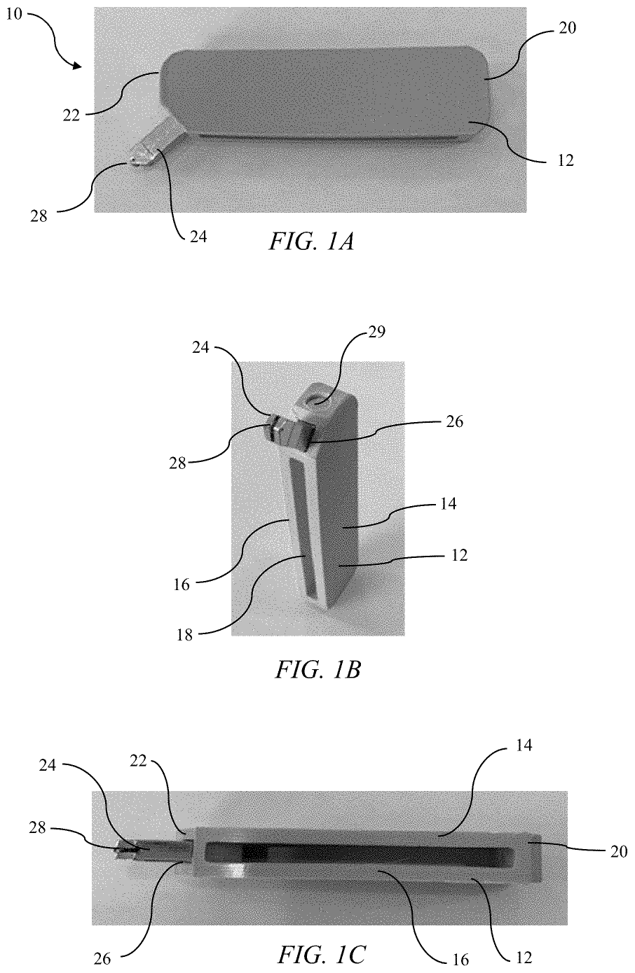

Now referring to the figures, wherein like numerals refer to like parts, FIGS. 1A-1C illustrates various views of a glass etching and breaking apparatus 10 in an embodiment of the present invention. The apparatus 10 comprises a body 12 having a first bridging leg 14 and a second bridging leg 16 spaced apart and disposed in parallel relationship to each other, with a space 18 therebetween. The first bridging leg 14 is connected to the second bridging leg 16 on a first end 20 and on a second end 22.

The first bridging leg 14 and the second bridging leg 16 each have a degree of flex, such that pressing down on one or both of the first and second bridging legs 14, 16 causes them to deflect towards each other. When released, each of the first and second bridging legs 14, 16 retain their original position. Thus, each of the first and second bridging legs 14, 16 acts as a leaf spring, where deformation of each may be caused by pressing on each, but each springs back to its original position when the pressure is released.

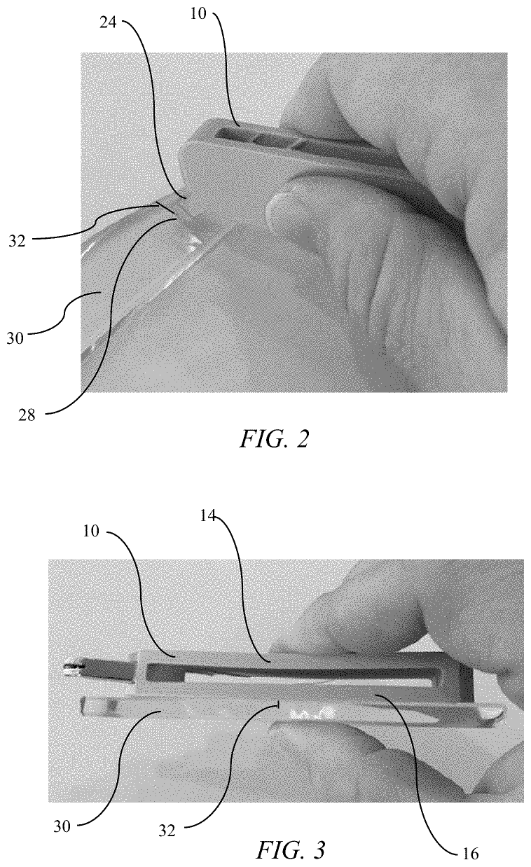

Extending from the second end 22, preferably at an oblique angle to the sides of the base 12 may be a cutting tool 24, which may extend from a cavity 26. In one embodiment, the cutting tool 24 may be permanently sealed in the cavity 26. In a preferred embodiment, the cutting tool 24 may be removable from the cavity 26, as described in more detail below. A cutting wheel 28 may be disposed on an end of the cutting tool 24 for etching a score line in a pane of annealed glass, as illustrated in FIG. 2. Of course, any other cutting element may be disposed on an end of the cutting tool 24 for etching a score line in glass, such as a diamond tip, or other like element, and the present invention should not be limited as described herein.

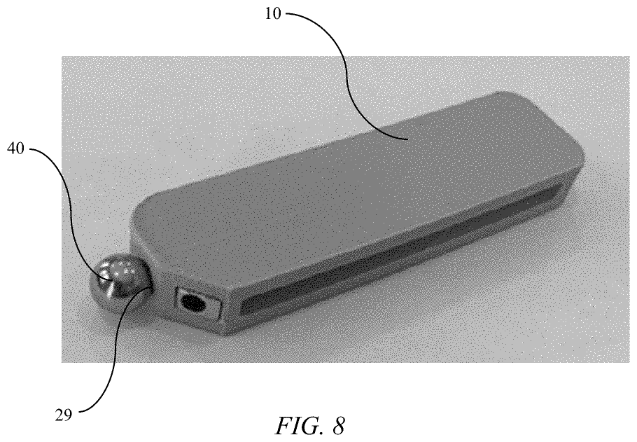

A magnet 29 may be positioned within the second end 22 of the apparatus 10, which may have multiple functionalities. In an embodiment, the magnet 29 may hold the cutting tool 24 within the cavity 26 so that the same does not readily fall out of the cavity 26 when in use. In addition, or alternatively, the magnet 29 may be utilized by a user to magnetically attract magnetic or metallic items, such as metal item 40 (showing a metal ball that may be used in the etching and breaking of the glass, as apparent to one of ordinary skill in the art) as shown in FIG. 8.

As shown in FIG. 2, a user may grasp the apparatus 10 and apply the cutting tool 24, more specifically, the cutting wheel 28 on the end thereof, to a pane of glass 30 and, applying pressure, may etch a score line 32 into the glass 30. As illustrated in FIG. 3, the glass may be placed against one of the legs 14, 16 and the apparatus 10 and the glass 30 may be squeezed by the user thereof, which causes the legs 14, 16 to flex toward each, causing the glass 30 to also flex, which consequently causes the glass 30 to break along the score line 32 etched therein by the cutting tool.

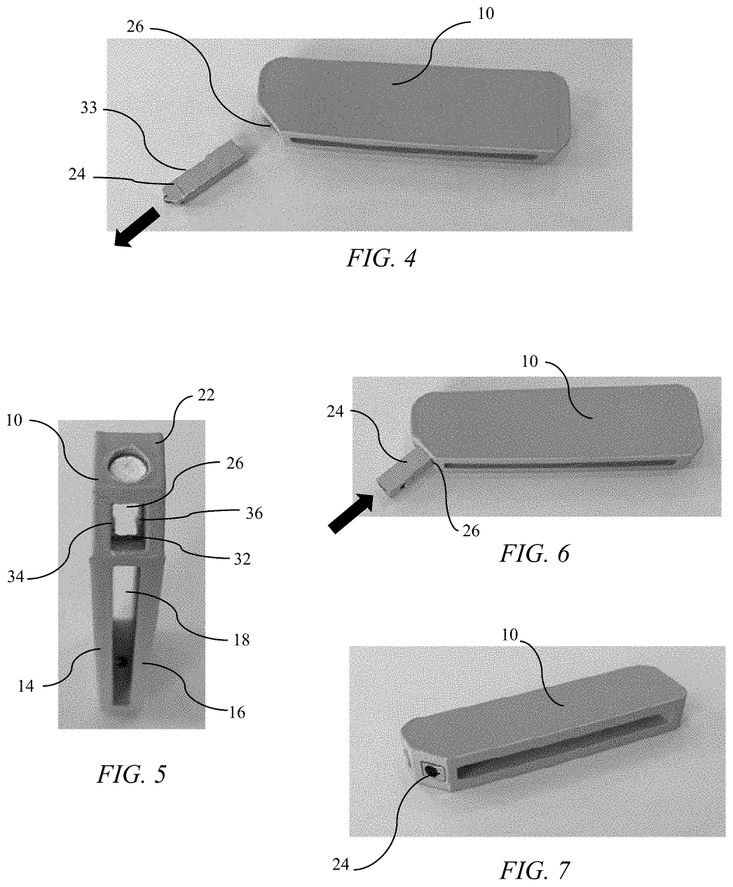

Referring now to FIGS. 4-7, in a preferred embodiment of the present invention, the cutting tool 24 may be removed from the cavity 26, as illustrated in FIG. 4. As noted above, the magnet 29 may provide an attractive force that may be prevent the cutting tool 24 from falling out of the cavity 26, but may be sufficiently weak to allow a user to pull the cutting tool 24 therefrom. Therefore, the cutting tool 24 may be easily replaced if necessary, such as when the cutting wheel 28 becomes dull.

Alternatively, the cutting tool 24 may be turned around and disposed within the cavity 26 for storage of the same out of the way, as illustrated in FIGS. 6-7, showing the cutting tool 24 turned around and disposed fully within the cavity 26. To prevent the cutting tool 24 from extending fully within the cavity 26 when the cutting wheel is disposed outwardly, a tab 32 may be disposed within the cavity 26, which may catch the end of the cutting tool and prevent further egress within the cavity 26. The cutting tool may further have a reduced area 33, as illustrated in FIG. 4, such that when the cutting tool 24 is turned around and placed into the cavity 26, the tab 32 does not catch the cutting tool 24, and the cutting tool 24 is allowed to be fully inserted into the cavity 26.

Guide ridges 34, 36 may extend within the cavity 26 on inside surfaces of the legs 14, 16, respectively, to guide the cutting tool 24 as it is fully inserted therein. Therefore, the cutting tool 24 may be placed therein and stored within the cavity 26 when not in use so the same is not lost. Moreover, the cutting tool 24 may be removed and placed within the cavity 26 when the apparatus 10 is used in a manner in which the cutting tool 24 would get in the way. For example, as illustrated in FIG. 8, the cutting tool 24 may interfere with the proper usage of the magnet 29 for attracting magnetic or metal objects, so when used in such a manner, the cutting tool 24 may be removed and stowed within the cavity 26 as described herein. Simply shaking the apparatus 10 may allow the cutting tool 24 to be removed from the cavity 26, although the cutting tool may be forced out by pushing the same out the other side, or removing the same via another method.

It should be noted that various changes and modifications to the presently preferred embodiments described herein will be apparent to those skilled in the art. Such changes and modifications may be made without departing from the spirit and scope of the present invention and without diminishing its attendant advantages. Further, references throughout the specification to “the invention” are nonlimiting, and it should be noted that claim limitations presented herein are not meant to describe the invention as a whole. Moreover, the invention illustratively disclosed herein suitably may be practiced in the absence of any element which is not specifically disclosed herein.

I claim:

1. A glass etching and breaking apparatus comprising:
a body comprising a first bridging leg and a second bridging leg in parallel relationship and a space therebetween, the first bridging leg configured to flex when pressure is applied thereto and to return to its original position when the pressure is removed, the first bridging leg connected to the second bridging leg at a first end of the body and the first bridging leg connected to the second bridging leg at the second end of the body; and
a glass cutting tool extending from one of the first and second ends of the body, the glass cutting tool comprising a glass cutting element on an end thereof, the glass cutting tool extending from a cavity within the body.

2. The glass etching and breaking apparatus of claim 1 wherein the cutting tool is removable from the cavity.

3. The glass etching and breaking apparatus of claim 1 wherein the cavity comprises a tab, wherein the tab holds the glass etching and breaking apparatus in a first position, wherein when in the first position, a portion of the cutting tool extends from the body.

4. The glass etching and breaking apparatus of claim 3 wherein when the cutting tool is turned around such that the cutting element is inserted first into the cavity, the cavity is configured to hold the cutting tool without any portion of the cutting tool extending from the body.

5. The glass etching and breaking apparatus of claim 4 wherein the cutting tool comprises a reduced portion, such that when the cutting tool is turned around and when the cutting element is inserted first into the cavity, the reduced portion of the cutting tool clears the tab within the cavity.

6. The glass etching and breaking apparatus of claim 4 wherein the first bridging leg has a first ridge on an inside surface thereof, wherein the first ridge guides the cutting tool when inserted into the cavity with the cutting element inserted first.

7. The glass etching and breaking apparatus of claim 6 wherein the second bridging leg has a second ridge on an inside surface thereof, wherein the second ridge guides the cutting tool when inserted into the cavity with the cutting element inserted first.

8. The glass etching and breaking apparatus of claim 1 further comprising:
a magnet disposed in the body proximate the cavity.

9. The glass etching and breaking apparatus of claim 1 wherein the second bridging leg is configured to flex when pressure is applied thereto and to return to its original position when the pressure is removed.

10. The glass etching and breaking apparatus of claim 1 wherein the cutting tool extends from the body at an oblique angle to the sides of the body.

11. A method of using a glass etching and breaking apparatus comprising the steps of:
providing a glass etching and breaking apparatus comprising: a body comprising a first bridging leg and a second bridging leg in parallel relationship and a space therebetween, the first bridging leg configured to flex when pressure is applied thereto and to return to its original position when the pressure is removed, the first bridging leg connected to the second bridging leg at a first end of the body and the first bridging leg connected to the second bridging leg at the second end of the body; and a glass cutting tool extending from one of the first and second ends of the body, the glass cutting tool comprising a glass cutting element on an end thereof, the glass cutting tool extending from a cavity within the body;
etching a score line into pane of glass with the cutting tool;
placing the pane of glass against a side of the body of the glass etching and breaking apparatus;
pressing the score line of the pane of glass against the side of the body of the glass etching and breaking apparatus, thereby flexing the first leg thereof; and
breaking the glass at the score line.

12. The method of claim 11 further comprising the step of:
removing the cutting tool from the cavity.

13. The method of claim 11 wherein the cavity comprises a tab, wherein the tab holds the glass etching and breaking apparatus in a first position, wherein when in the first position, a portion of the cutting tool extends from the body.

14. The method of claim 13 further comprising the step of:
inserting the cutting tool into the cavity with the cutting element inserted first into the cavity, wherein the cavity is configured to hold the cutting tool without any portion of the cutting tool extending from the body.

15. The method of claim 14 wherein the cutting tool comprises a reduced portion, further comprising the step of:
clearing the tab within the cavity with the reduced portion of the cutting tool when the cutting tool is inserted into the cavity with the cutting element inserted first.

16. The method of claim 14 wherein the first bridging leg has a first ridge on an inside surface thereof, further comprising the step of:
guiding the cutting tool with the first ridge when the cutting tool is inserted into the cavity with the cutting element inserted first.

17. The method of claim 16 wherein the second bridging leg has a second ridge on an inside surface thereof, further comprising the step of:
guiding the cutting tool with the second ridge when the cutting tool is inserted into the cavity with the cutting element inserted first.

18. The method of claim 11 further comprising the steps of:
providing a magnet disposed in the body proximate the cavity; and
holding the cutting tool within the cavity with the magnet.

19. The method of claim 18 further comprising the step of:
holding a magnetic or metal item with the magnet.

20. The method of claim 11 wherein the second bridging leg is configured to flex when pressure is applied thereto and to return to its original position when the pressure is removed.
